(19) United States
(12) Patent Application Publication
(10) Pub. No.: US 2019/0035377 A1
(43) Pub. Date: Jan. 31, 2019

(54) LOW THICKNESS PERFORATED MILLE-FEUILLE ACOUSTIC RESONATOR FOR ABSORBING OR RADIATING VERY LOW ACOUSTIC FREQUENCIES

(71) Applicant: UNIVERSITE DE BOURGOGNE, Dijon (FR)

(72) Inventors: Philippe LECLAIRE, Nevers (FR); Thomas DUPONT, Nevers (FR); Shahram AIVAZZADEH, Nevers (FR)

(21) Appl. No.: 16/075,093

(22) PCT Filed: Feb. 1, 2017
(86) PCT No.: PCT/EP2017/052183

§ 371 Date: Aug. 2, 2018

(30) Foreign Application Priority Data
Feb. 5, 2016 (FR) 1650926

(51) Int. Cl. G10K 11/172

(52) U.S. Cl. CPC G10K 11/172

(57) ABSTRACT

An acoustic resonator includes a resonance part provided with a main perforation extending in a direction of propagation and a series of lateral cavities communicating with the main perforation so as to form very thin acoustic resonators, each lateral cavity opening onto the main perforation via the entire perimeter of a respective segment of this main perforation, and the lateral cavities constituting fluid laminae such that the resonance part presents a multilayer structure comprising these fluid laminae and layers of a material of the resonance part separating these fluid laminae.

### TECHNICAL FIELD

The present invention relates to the field of acoustic resonators. More specifically, the present invention relates to a resonator that can be used in an application of the acoustic absorption type, for example as an absorbent or silencing material, or in an application of the acoustic radiation type, for example of the loudspeaker port (“bass-reflex” box) type.

### STATE OF THE PRIOR ART

Polyurethane foams, fibrous materials of the glass wool type, or also melamine foams, are materials commonly used to produce acoustic absorption. Such porous materials are included among the most absorbent materials and are generally efficient for absorbing high frequencies, typically above 1 kHz. However, these porous materials are generally not very efficient for absorbing low frequencies, typically below 1 kHz. More generally, a drawback of such porous materials is that the efficiency of absorption is proportional to the thickness of the material. By way of example, the inventors estimate that the same value of the absorption coefficient at a frequency of 500 Hz by a melamine foam would mean that this foam would be at least several tens of centimetres thick.

Acoustic absorption devices are also known from the prior art of the type containing a tunnel suitable for receiving and propagating an acoustic wave, and containing lateral cavities forming Helmholtz resonators. By way of example, the following documents describe such devices:
Sugimoto N., Horioka T., Dispersion characteristics of sound waves in a tunnel with an array of Helmholtz resonators, J. Acoust. Soc. Am. 97, 1446-1459, 1995 (hereinafter SUGIMOTO 95);
EP1291570 A2.

In the SUGIMOTO 95 document, each of the lateral cavities opens onto the tunnel by an orifice of the point type cut in the wall of the tunnel. In the document EP1291570 A2, the side apertures extend circumferentially, parallel to the tunnel (see FIG. 5b of this document).

In general terms, systems provided with Helmholtz resonators are capable of absorbing low frequencies, typically below 1 kHz. The absorption of low frequencies nevertheless assumes that the dimensions of the resonator are relatively large. Thus the inventors consider that in order to obtain a resonance frequency of 500 Hz with a cavity forming a resonator, this cavity should have a length of the order of 17 cm.

Another type of acoustic absorption device is described in the following document, some of the authors of which are also inventors of the present invention:
Leclaire P., Umnova O., Dupont T., Panneton R., Acoustical properties of air-saturated porous material with periodically distributed dead-end pores, J. Acoust. Soc. Am., 137(4), 1772-1782, 2015 (hereinafter LECLAIRE 15).

The document LECLAIRE 15 describes a material containing several main perforations suitable for receiving and for propagating an acoustic wave, and containing lateral perforations of the “dead-end pores” type.

A purpose of the invention is to propose an acoustic resonator having a small thickness capable of absorbing low frequencies, typically below 1 kHz.

A further purpose of the invention is to propose an acoustic resonator that can also operate in an application of the acoustic radiation type.

### DISCLOSURE OF THE INVENTION

To this end, the invention proposes an acoustic resonator comprising a resonance part provided with:
a main perforation passing right through the resonance part, the main perforation extending in a direction of propagation, this main perforation being suitable for receiving and propagating at least one acoustic wave in the direction of propagation,
a series of lateral cavities communicating with the main perforation in such a way as to form acoustic resonators, each lateral cavity extending transversally with respect to the direction of propagation,
   the main perforation and the lateral cavities being filled with a fluid, this fluid preferably being air (or alternatively, capable of being for example water),
   each lateral cavity opening onto the main perforation via the entire perimeter of a respective segment of this main perforation,
   the lateral cavities constituting fluid laminae such that the resonance part presents a “multilayer” structure comprising these fluid laminae and layers of a material of the resonance part separating these fluid laminae.

In other words, the resonance part presents a multilayer structure, formed by alternating fluid laminae and layers of material.

The resonance part can be produced from a single block of material or by assembly and bonding of several elements, for example machined separately.

In the case where the fluid is air and the material is a metal, the multilayer structure of the resonator according to the invention is thus characterized by a succession of metal layers and air laminae, throughout the resonance part in the direction of propagation.

By way of non-limitative illustration, for such a resonance part comprising two lateral cavities, the multilayer structure would comprise successively: a metal layer, an air lamina, a metal layer, an air lamina and a metal layer.

Such a resonator provided with such a multilayer structure makes it possible to maximize the exchange surface between the material of the resonance part and the fluid filling the main perforation and the lateral cavities. Heat exchanges within the fluid laminae and the exchanges by convection between the main perforation and the lateral cavities result in a considerable increase in the compressibility of the fluid in the main perforation and therefore, in particular, a considerable increase in the acoustic absorption of low frequencies.

Preferably, the resonance part can be produced from a metal material. A metal material facilitates production of the resonance part. According to variants, the resonance part can be produced from any other material, for example from a plastic material.

Preferably, the lateral cavities can be spaced apart regularly along the direction of propagation. Regular spacing of the lateral cavities, i.e. a periodic arrangement of the fluid laminae, promotes heat exchanges between the main perforation and the lateral cavities, which results in an increase in the compressibility of the fluid in the main perforation and in particular, makes absorption of relatively low frequencies possible. Preferably, the lateral cavities extend perpendicularly with respect to the direction of propagation.

In an embodiment, each layer of material separating the fluid laminae can have a thickness equal to a thickness of a lateral cavity.

This characteristic makes it possible to optimize the heat exchange effects of the multilayer structure for a reduced total dimension of the resonance part in the direction of propagation.

Preferably, each of the lateral cavities and/or each layer of material separating the fluid laminae can have a thickness less than 3 mm, preferably less than 2 mm, preferably less than or equal to 1 mm. Preferably, each of the lateral cavities and/or each layer of material separating the fluid laminae can thus have a thickness of a few hundred micrometres.

In an embodiment, each of the lateral cavities, or fluid laminae, can have a thickness defined by two transverse planes that are parallel to one another and are not parallel to the direction of propagation. Preferably, these transverse planes can be perpendicular to the direction of propagation, such that the lateral cavities extend perpendicularly with respect to the direction of propagation.

In an embodiment, each of the lateral cavities can form a volume delimited by:
two first lateral planes parallel to the direction of propagation and parallel to one another, these two first lateral planes defining a height of a lateral cavity,
two second lateral planes parallel to one another and perpendicular to the first lateral planes, these two second lateral planes defining a width of a lateral cavity, the width of a lateral cavity preferably being equal to the height of a lateral cavity,
said two transverse planes defining said thickness of a lateral cavity, such that the volume is parallelepipedal.

In this latter embodiment, with respect to said parallelepipedal volume, the ratio of the height to the thickness of a lateral cavity, and/or the ratio of the width to the thickness of a lateral cavity, can preferably be greater than 15, preferably greater than 20, preferably equal to 25.

In variants of the invention, each of the lateral cavities can form a non-parallelepipedal volume, for example a disk, a straight or incurved hexagonal prism, etc.

Preferably, the ratio of the cross section of each of the lateral cavities to the section of the main perforation can be greater than 75, preferably greater than 125, preferably comprised between 150 and 160.

In this document, by “section” is meant a shape defined by the intersection of a volume with a plane.

In particular, the expression “cross section” of a lateral cavity denotes the shape defined by the intersection of this cavity with a median plane of this lateral cavity cutting the direction of propagation at the corresponding segment of the main perforation. Thus, when the lateral cavities extend perpendicularly with respect to the direction of propagation, the cross section of a lateral cavity is the shape defined by the intersection of this lateral cavity with a plane perpendicular to the direction of propagation.

Similarly, the section of the main perforation is the shape defined by the intersection of a volume constituted by this perforation with a plane perpendicular to the direction of propagation, this plane passing through one of said layers of material.

Preferably, the height and/or the width of a lateral cavity can be greater than or equal to 25 mm, preferably greater than 30 mm, preferably equal to 50 mm.

In an embodiment, the main perforation can have a square section. Alternatively and non-limitatively, the section of the main perforation can be round, or any other shape.

In an embodiment, the main perforation can have a section less than 24 mm², preferably less than 9 mm², preferably equal to 4 mm².

Such a geometry and/or such dimensions of the lateral cavities and/or the resonance part promote the heat and convection effects within the resonator.

In particular, air laminae of relatively large lateral dimensions D1 and D2 constitute relatively large heat exchange surfaces.

The resonator according to the invention makes it possible to produce acoustic absorption of low frequencies, typically less than 1 kHz, for a reduced total dimension of the resonance part, at least in the direction of propagation. In fact, the total thickness of the resonance part in the direction of propagation can in particular be less than 4 cm, which constitutes a relatively small thickness in comparison with the acoustic absorption capacities of the resonator.

The resonator according to the invention also makes it possible to produce acoustic radiation for a reduced total dimension of the resonance part, at least in the direction of propagation.

### DESCRIPTION OF THE FIGURES AND EMBODIMENTS

Other advantages and features of the invention will become apparent on examination of the detailed description of embodiments which are in no way limitative, and the attached drawings, in which

FIG. 1 is a perspective cross-section view of a resonator according to the invention, showing a series of five lateral cavities;

FIG. 2 is a front view of the resonator in FIG. 1.

FIG. 3 is a side view of a resonator according to the invention, showing a series of fifteen lateral cavities extending perpendicularly with respect to a direction of propagation;

FIG. 4 is a sectional side view of a resonator according to the invention, showing a series of four lateral cavities extending obliquely with respect to a direction of propagation;

FIG. 5 shows experimental results obtained by the inventors with resonators according to the invention.

As the embodiments described hereinafter are in no way limitative, variants of the invention can be considered comprising only a selection of the characteristics described, in isolation from the other characteristics described (even if this selection is isolated within a sentence containing these other characteristics), if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

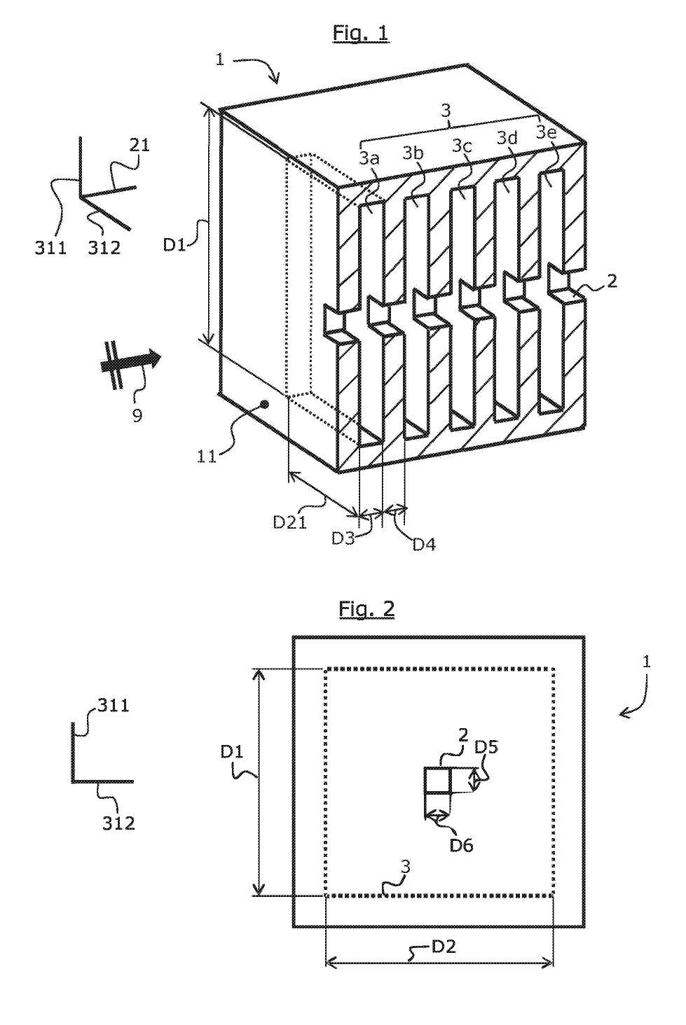

FIGS. 1 and 2 show an acoustic resonator according to the invention.

This resonator comprises a resonance part 1 consisting, in this example, of a block having a parallelepipedal shape. The resonance part 1 is preferably produced from a metal material or from any other material.

The resonance part 1 comprises a main perforation 2 passing right through the resonance part 1. The main perforation 2 extends in a direction of propagation 21.

The orthogonal frame of reference in FIG. 1 shows the direction of propagation 21, a first lateral direction 311 and a second lateral direction 312, these three directions 21, 311 and 312 being perpendicular to one another.

The main perforation 2 is suitable for receiving and propagating at least one acoustic wave 9 in the direction of propagation 21. In particular, such an acoustic wave 9 can be received in the resonance part 1 via the aperture formed by the main perforation 2 in a receiving surface 11 of the resonance part 1 exposed to a surrounding space in which the at least one acoustic wave 9 propagates. Received in this way in the resonance part 1, the at least one acoustic wave 9 can propagate in the resonance part 1 through the main perforation 2, typically so as to pass right through the resonance part 1.

The at least one acoustic wave 9 can be generated by any system or means, not being the subject of the present invention.

The resonance part 1 is also provided with a series of lateral cavities 3 communicating with the main perforation 2 so as to form acoustic resonators. In particular, such lateral cavities 3 typically make it possible to attenuate the frequencies of the at least one acoustic wave 9 during its propagation in the main perforation 2.

As shown in FIGS. 1 and 2 in particular, each lateral cavity 3a, 3b, 3c, etc. is produced inside the resonance part 1. In other words, each lateral cavity 3a, 3b, 3c, etc. forms an internal volume in the resonance part 1.

The main perforation 2 and the lateral cavities 3a, 3b, 3c, etc. are filled with a fluid. Typically, this fluid is air. This fluid thus occupies said surrounding space in which the at least one acoustic wave 9 propagates.

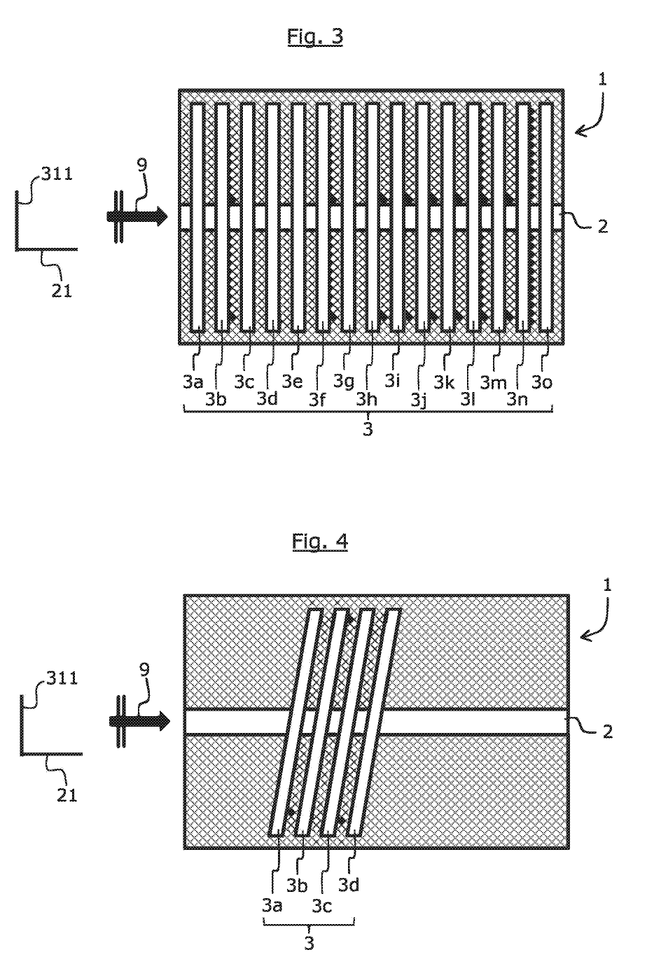

According to the invention, each lateral cavity 3a, 3b, 3c, etc. extends transversally with respect to the direction of propagation 21. In the example in FIGS. 1 and 3, the lateral cavities 3a, 3b, 3c, etc. extend perpendicularly with respect to the direction of propagation 21. In the example in FIG. 4, the lateral cavities 3a, 3b, 3c and 3d, etc. extend obliquely with respect to the direction of propagation 21.

The lateral cavities 3a, 3b, 3c, etc. can be machined directly in the resonance part 1, for example using the technologies of 3D printing, structural bonding and assembly. The resonance part 1 can be produced from a single block of material or by assembly and bonding of several elements, for example machined separately.

According to the invention, each lateral cavity 3a, 3b, 3c, etc. opens onto the main perforation 2 via the entire perimeter of a respective segment of this main perforation 2. The drawings thus show, for example in FIG. 2, that the main perforation 2 is geometrically contained in the series of lateral cavities 3 relative to the first 311 and the second 312 lateral direction. Thus, with reference to FIG. 1, on the segment D3 of the main perforation 2, this segment D3 showing the thickness of the lateral cavity 3a in the direction of propagation 21, the result by geometrical construction is that the lateral cavity 3a opens onto the main perforation 2 via the entire perimeter of the segment D3 of the main perforation 2. The same holds true for each of the other lateral cavities 3b, 3c, etc.

According to another important characteristic of the invention, the lateral cavities 3 constitute fluid laminae such that the resonance part 1 presents a multilayer structure comprising these fluid laminae and layers of a material of the resonance part 1 separating these fluid laminae. In other words, the multilayer structure alternately presents, on the one hand, fluid laminae filling the main perforation 2 and the lateral cavities 3a, 3b, 3c, etc. and on the other hand, layers of material forming the resonance part 1.

Preferably, the series of lateral cavities 3 comprises at least three lateral cavities. The embodiment shown in FIG. 3 represents a resonance part 1 provided with a series of fifteen lateral cavities 3a, 3b, 30.

The lateral cavities 3a, 3b, 3c, etc. can be arranged periodically, i.e. they can be spaced apart regularly along the direction of propagation 21. Such a periodic arrangement promotes heat exchanges between the lateral cavities 3a, 3b, 3c, etc. and the main perforation 2, and results in an increase in the compressibility of the fluid in the main perforation 2.

Preferably, the thickness D3 of each lateral cavity is identical for all the lateral cavities. Preferably, the thickness D4 of each layer of material separating the fluid laminae is identical for all the adjacent pairs of lateral cavities.

In the embodiments shown in FIGS. 1 and 3, each layer of material separating the fluid laminae has a thickness D4 equal to the thickness D3 of a lateral cavity.

With reference to FIGS. 1 to 3, the lateral cavities 3a, 3b, 3c, etc. form a parallelepipedal volume. Such a volume can be defined geometrically as follows.

Each of the lateral cavities 3a, 3b, 3c, etc., or fluid laminae, has a thickness D3 defined by two transverse planes that are parallel to one another, and are not parallel to the direction of propagation 21. In the embodiments in FIGS. 1 and 3, these two transverse planes are perpendicular to the direction of propagation 21.

Each of the lateral cavities 3a, 3b, 3c, etc. forms a volume delimited by:
two first lateral planes parallel to the direction of propagation 21 and parallel to one another, these two first lateral planes defining a height D1 of a lateral cavity,
two second lateral planes parallel to one another and perpendicular to the first lateral planes, these two second lateral planes defining a width D2 of a lateral cavity,
said two transverse planes defining said thickness D3 of a lateral cavity,
   such that the volume is parallelepipedal.

In the example in FIG. 2, the width D2 is equal to the height D1. FIG. 1 is a sectional view of the resonance part 1, in which is apparent, for the lateral cavity 3a only, the half-width D21 of this lateral cavity 3a.

The dimensional characteristics of the lateral cavities 3a, 3b, 3c, etc. and/or of the main perforation 2 can also contribute, in the case of an application of the acoustic absorption type, to producing absorption of low frequencies, typically below 1 kH, while still producing a resonator of small thickness, in particular of small dimensions of the resonance part 2 in the direction of propagation 21.

According to different compatible embodiments:
the thickness D3 of a lateral cavity is less than 3 mm, preferably less than 2 mm, preferably less than or equal to 1 mm;
the thickness D4 of a layer of material separating the fluid laminae is less than 3 mm, preferably less than 2 mm, preferably less than or equal to 1 mm;
the ratio of the height D1 to the thickness D3, and/or the ratio of the width D2 to the thickness D3, is greater than 15, preferably greater than 20, preferably equal to 25;
the ratio of the cross section of each of the lateral cavities, defined by the product of the height D1 and the width D2 of a lateral cavity, to the section of the main perforation 2, defined by the product of the dimensions D5 and D6 shown in FIG. 2, is greater than 75, preferably greater than 125, preferably comprised between 150 and 160;
the height D1 and/or the width D2 of a lateral cavity is greater than or equal to 25 mm, preferably greater than 30 mm, preferably equal to 50 mm.

In the example in FIGS. 1 and 2, the main perforation 2 has a square section. This square section is defined by two sides D5 and D6. In an alternative embodiment, the main perforation 2 has a circular section.

In a variant embodiment of the invention, the volume of each lateral cavity 3a, 3b, 3c, etc. is cylindrical (not shown). In such a variant, the cross section of each of the lateral cavities is circular.

In terms of dimensions, the main perforation 2 can have a section of less than 24 mm², preferably less than 9 mm², preferably equal to 4 mm².

First Series of Tests

By way of experiment, the inventors produced eight acoustic resonators according to the invention in order to test their capabilities in an application of the acoustic absorption type. For each of these resonators, the main perforation 2 had a square section of 4×4 mm, and the resonance part 1 was provided with a series of fifteen lateral cavities of dimensions D1=D2=25 mm and D3=1 mm, the thickness D4 of each layer of material separating the lateral cavities being 1 mm.

Tests in impedance tubes were carried out so as to measure the acoustic absorption coefficient of these resonators.

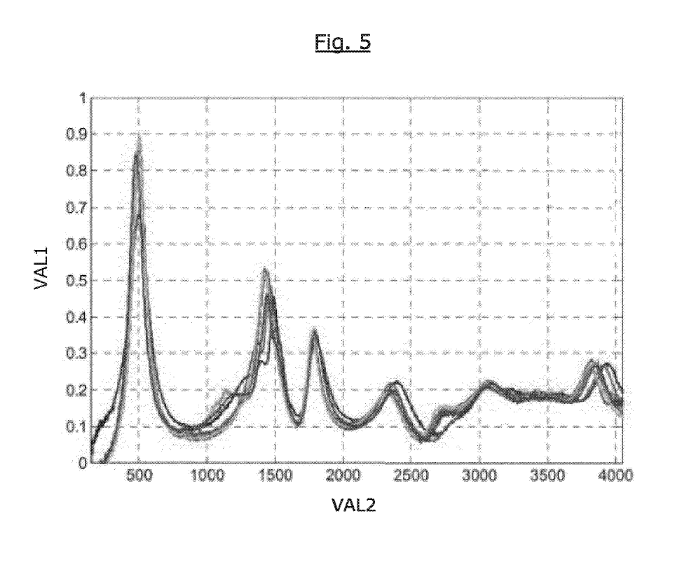

FIG. 5 shows the absorption coefficient curves during these tests (one curve per resonator tested), VAL1 on the y axis representing the absorption coefficient, VAL2 on the x axis representing the frequency in Hz.

These curves show that the resonator according to the invention makes it possible to obtain, reproducibly, an absorption peak at a frequency lower than 500 Hz for a total thickness of the resonator (dimension of the resonance part 1 in the direction of propagation 21) of 31 mm.

Second Series of Tests

In a second series of tests, the inventors produced an acoustic resonator according to the invention to test its capabilities in an application of the acoustic absorption type and in an application of the acoustic radiation type. The main perforation 2 had a circular section and a diameter of 6.5 mm. The resonance part 1 was provided with a series of fifteen lateral cavities having a circular section with a diameter of 21.3 mm and a thickness D3 of 1 mm. The thickness D4 of each layer of material separating the lateral cavities was 1.2 mm. The total thickness of the resonance part 1 in the direction of propagation was 35.3 mm.

Tests were carried out so as to measure:
on the one hand, the acoustic absorption coefficient of the resonator placed in an acoustic tube and subjected to plane wave acoustic excitation,
on the other hand, the acoustic radiation of the resonator placed in an enclosure provided with absorbent materials and excited by an air jet.

These tests showed that this resonator makes it possible to obtain resonance frequencies close to the frequency values of the absorption peaks, in particular a frequency on the main resonance close to 1000 Hz for radiation and for absorption, this for a total thickness of the resonance part 1 in the direction of propagation of 35.3 mm. In comparison with the conventional systems, the researchers consider that the absorption or the radiation of such a frequency would require respectively a cavity or a tube of 85.8 mm in length.

Of course, the invention is not limited to the examples which have just been described and numerous adjustments can be made to these examples without exceeding the scope of the invention. For example, the resonance part 1 can be provided with secondary perforations parallel to the main perforation 2. In addition, the different characteristics, forms, variants and embodiments of the invention can be combined together in various combinations to the extent that they are not incompatible or mutually exclusive.

1. An acoustic resonator comprising a resonance part provided with:
a main perforation passing right through the resonance part, the main perforation extending in a direction of propagation, this main perforation being suitable for receiving and propagating at least one acoustic wave in the direction of propagation;
a series of lateral cavities communicating with the main perforation in such a way as to form acoustic resonators, each lateral cavity extending transversally with respect to the direction of propagation;
the main perforation and the lateral cavities being filled with a fluid;
each lateral cavity opens onto the main perforation via the entire perimeter of a respective segment of this main perforation;
the lateral cavities constitute fluid laminae such that the resonance part presents a multilayer structure comprising these fluid laminae and layers of a material of the resonance part separating these fluid laminae;
the ratio of the cross section of each of the lateral cavities to the section of the main perforation is greater than 75.

2. The resonator according to claim 1, characterized in that the lateral cavities are spaced apart regularly along the direction of propagation.

3. The resonator according to claim 1, characterized in that the lateral cavities extend perpendicularly with respect to the direction of propagation.

4. The resonator according to claim 1, characterized in that each layer of material separating the fluid laminae has a thickness equal to a thickness of a lateral cavity.

5. The resonator according to claim 1, characterized in that each of the lateral cavities and/or each layer of material separating the fluid laminae has a thickness less than 3 mm, preferably less than 2 mm, preferably less than or equal to 1 mm.

6. Resonator The resonator according to claim 1, characterized in that each of the lateral cavities, or fluid laminae, has a thickness defined by two transverse planes that are parallel to one another, and are not parallel to the direction of propagation.

7. The resonator according to claim 6, characterized in that each of the lateral cavities forms a volume delimited by:
two first lateral planes parallel to the direction of propagation and parallel to one another, these two first lateral planes defining a height of a lateral cavity;
two second lateral planes parallel to one another and perpendicular to the first lateral planes, these two second lateral planes defining a width of a lateral cavity; and
said two transverse planes defining said thickness of a lateral cavity, such that the volume is parallelepipedal.

8. The resonator according to claim 7, characterized in that, with respect to said parallelepipedal volume, the ratio of the height to the thickness of a lateral cavity, and/or the ratio of the width to the thickness of a lateral cavity, is greater than 15, preferably greater than 20, preferably equal to 25.

9. The resonator according to claim 1, characterized in that the ratio of the cross section of each of the lateral cavities to the section of the main perforation is greater than 125, preferably comprised between 150 and 160.

10. The resonator according to claim 7, characterized in that the height and/or the width of a lateral cavity is greater than or equal to 25 mm, preferably greater than 30 mm, preferably equal to 50 mm.

11. The resonator according to claim 1, characterized in that the main perforation has a square section.

12. Resonator The resonator according to claim 1, characterized in that the main perforation has a section of less than 24 mm², preferably less than 9 mm², preferably equal to 4 mm².
